(19) United States
(12) Patent Application Publication
(10) Pub. No.: US 2004/0221318 A1
(43) Pub. Date: Nov. 4, 2004

(54) Addressable tap with channel tier functions

(76) Inventors: Yung-Liang Chang, KaoHsiung City (TW); Chih-Chou Shih, Taichung City (TW)

Correspondence Address: Judson K. Champlin, Westman, Champlin & Kelly, Suite 1600, 900 Second Avenue South, Minneapolis, MN, 55402-3319, US

(21) Appl. No.: 10/827,560

(22) Filed: Apr. 19, 2004

(30) Foreign Application Priority Data
Apr. 29, 2003 (CN) 03225814.3

(51) Int. Cl. H04N 7/173; H04N 7/16

(52) U.S. Cl. 725/127; 725/120; 725/145; 725/25

(57) ABSTRACT

An addressable tap with channel tier function consisting of housing and a power supply module, a filter and demodulation module, a control module and RF switches inside said housing, which are electrically connected to said control module. Besides, it also includes secondary RF switches and high/low-pass filters. Each of said RF switches is electrically connected to at least to two secondary RF switches, which are electrically connected to said control module separately and at the same time connected to at least two low-pass filters to form a terminal together with said low-pass filters of said RF switch in parallel; Compared with the existing technology, the current invention has the following effects: Filter has high precision; Bandwidth/Channel isolation is higher than 50 dB; it is only necessary to directly replace the existing non-addressable taps in CATV network with the current invention addressable taps without extra wiring. It is easy in installation at low costs.

### FIELD OF INVENTION

This invention is directed to the image communication technological sector, especially an addressable tap used in CATV for payment collection.

### BACKGROUND OF THE INVENTION

For customers have different consuming power and requirements, CATV networks provide different bandwidth/channel for users to select and CATV operators collect fees in different grades according to users' selection of bandwidth/channel. Channel tier function of traditional addressable taps is realized by way of installation of setup box or programmable filters in TV sets of users. Both of the methods have many disadvantages. To be particular, installation of top box in TV sets have the following disadvantages: 1. High costs; 2. Installation must be done at users' house, which is inconvenient and difficult while using programmable filters have the following disadvantages: 1. Insufficient precision in switching bandwidth/channel; 2. Insufficient isolation of bandwidth/channel; 3. Large size of product that cannot be accommodated into the housing of the original addressable taps, which makes it necessary to upgrade the existing CATV network when such filters are put into use, resulting in great wastes of labor and materials.

### BRIEF SUMMERY OF THE INVENTION

Technical problems that the present invention aims to solve is avoiding the disadvantages in the existing technology by way of a new addressable tap, which has channel tier function and is easy in installation with high bandwidth/channel switching and high isolation grade.

The technical problems that this invention aims at can be solved by the following technical plan:

Design and use an addressable tap with channel tier function that consists of a housing and a power supply module, a filter and demodulation module, a control module and RF switches inside the housing. Said power supply module, filter and demodulation module, RF switches are electrically connected with said control module separately.

Besides, the tap also consists of secondary RF switches and high/low-pass filters. Said RF switches are electrically connected to at least two secondary RF switches, the secondary RF switches are electrically connected to said control module and at the same time connected to at least two high/low-pass filters separately to form a terminal together with said high/low-pass filters of said RF switch branch;

Said control module directly and separately controls each of said RF switches and said secondary RF switches connected to the RF switches to control their corresponding said high/low-pass filters, resulting in control over CATV signal channel tier selection by each user.

The present invention has two levels of RF switches to form four and each passage has high/low-pass filters separately. Compared with the existing technology, the current invention has the following effects:

1. Filter has high precision;

2. Bandwidth/Channel isolation is higher than 50 dB;

3. Product size is small, being able to be accommodated in the housing of original non-addressable taps. As the original taps can be upgraded outdoors, so it is not necessary to install the taps when user is at home, it is only necessary to directly replace the existing non-addressable taps in CATV network with the current invention addressable taps without extra wiring. It is easy in installation at low costs.

### BRIEF DESCRIPTION OF THE DRAWINGS

FIG. 1 is a three-dimensional appearance sketch of the current invention addressable tap;

FIG. 2 is an electric sketch diagram of said addressable tap;

FIG. 3 is a connecting sketch of RF switches 5, secondary RF switches 6 and high/low-pass filters 7.

### PREFERRED EMBODIMENT

Further introduction is made in combination with the attached drawings.

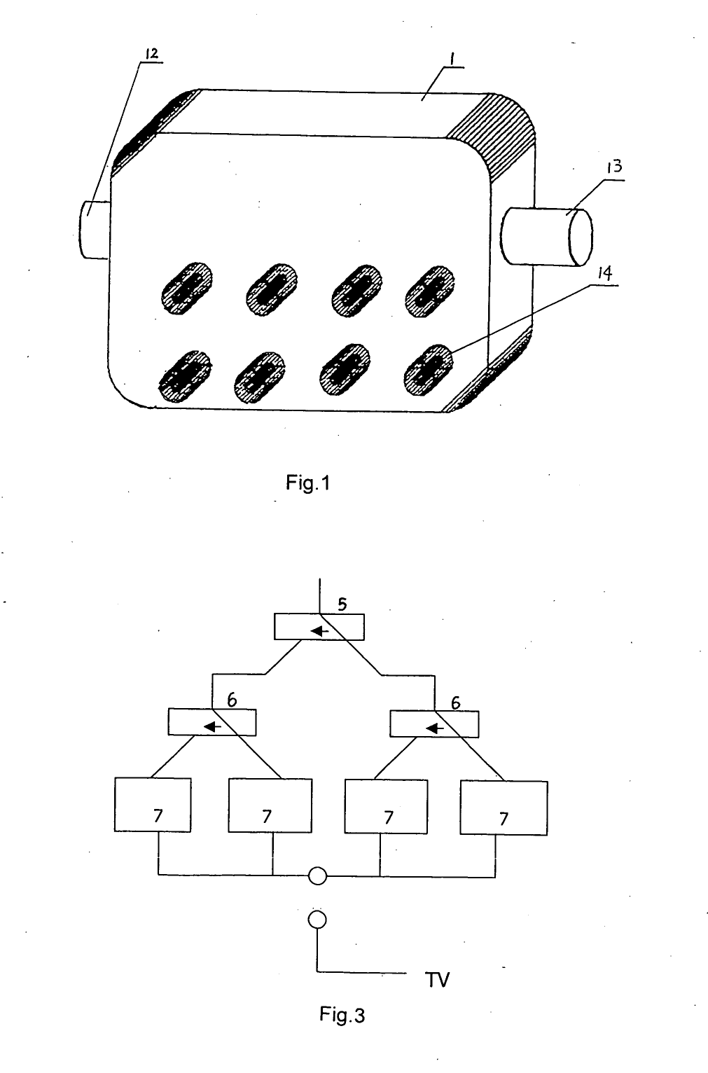

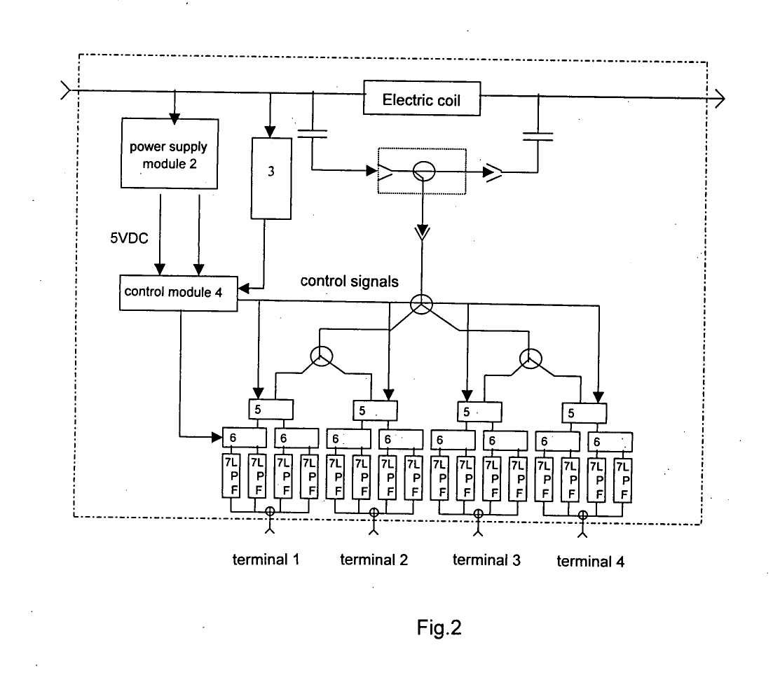

An addressable tap capable of channel tier function as shown in FIGS. 1 and 2 consists of a housing 1 and a power supply module 2, a filter and demodulation module 3, a control module 4 and eight RF switches 5, sixteen secondary RF switches 6 and thirty-two high/low-pass filters 7. Said power supply module 2, filter and demodulation module 3 and all the RF switches 5 are electrically connected with said control module 4 separately; each of said RF switches 5 is electrically connected to two secondary RF switches 6 and each secondary RF switch 6 is electrically connected to said control module 4 and also connected to two low-pass filters 7 separately to form a terminal together with the four said high/low-pass filters of said RF switch 5 in parallel. One terminal can be connected to a user.

As shown in FIG. 2, AC voltage of 60V-90V, control signal at 110 MHz and CATV signals are input at the input terminal. Said power supply module 2 will convert AC voltage of 60V-90V to DC voltage of 5V for said control module 4. At the same time, the filter and demodulation module 3 will demodulate the control signals inside the input signals and transmit them to said control module 4, which can control the RF switch 5 or the signal source after receiving the control signals from the filter and demodulation module 3. CATV signals and control signals inside the input are transmitted to the RF switches 5 through capacitors. Said control module 4 directly controls each of said RF switches 5 and the two secondary RF switches 6 connected to it to control the corresponding four said low-pass filters, resulting in control over CATV signal channel tier selection of each user. As shown in FIG. 3, the cut-off frequency of the first low-pass filter 7 reaches 250 MHz, the second low-pass filter 7 reaches 400 MHz, the third low-pass filter 7 reaches 550 MHz, while the fourth low-pass filter 7 allows CATV programs at all frequencies to be watched. In order to be more clearer, only 4 RF switches and one wire connecting secondary RF switch 6 and control module 4 are drawn in FIG. 2 (in fact, there is a connecting wire between every secondary RF switch 6 and control module 4).

As shown in FIG. 1, there is a signal input terminal 12 connected to the precedent addressable tap at the left side of said housing 1 and a main signal output terminal 13 connected to the posterior tap on the right side of said housing and there are eight output terminals 14 connected with the users on the front side of said housing 1. Dimensions, size and specification of said housing 1 are the same or compatible to the existing non-addressable taps used in CATV network, the faceplates of traditional taps installed can be replaced easily to realize enhancement of the function of channel tier function without the need of separate wire laying.

What is claimed is:

1. An addressable tap with channel tier function consisting of housing and a power supply module, a filter and demodulation module, a control module and RF switches inside said housing, which are electrically connected to said control module, is featured by:
It also includes secondary RF switches and high/low-pass filters;
Each of said RF switches is electrically connected to at least to two secondary RF switches, which are electrically connected to said control module separately and at the same time connected to at least two low-pass filters to form a terminal together with said low-pass filters of said RF switch n parallel;
Said control module directly and separately controls each of said RF switches and the secondary RF switches connected to it to control the corresponding low-pass filters, resulting in control over each user in selection of CATV channel tiers.

2. An addressable tap with channel tier function as defined in claim 1 is featured by: said RF switches are eight in number.

3. An addressable tap with channel tier function as defined in claim 1 is featured by: there is a signal input terminal connected to the precedent addressable tap at the left side of said housing and a main signal output terminal connected to the posterior tap on the right side of said housing and there are eight output terminals connected with the users on the front side of said housing.

4. An addressable tap with channel tier function as defined in claim 1 is featured by: dimensions of said housing are within plus minus 30% of standard housings of the existing non-addressable tap in order to replace the faceplates of traditional taps installed easily to realize enhancement of the function of channel tier.
